(19) United States
(12) Patent Application Publication
(10) Pub. No.: US 2026/0284512 A1
(43) Pub. Date: Sep. 24, 2026

(54) Miniature Optical Interruption Sensor Assembly

(71) Applicant: Turner Logic, LLC, Boerne, TX (US)

(72) Inventors: Christopher Turner, Boerne, TX (US); Gabriel Hernandez, San Antonio, TX (US)

(21) Appl. No.: 19/571,476

(22) Filed: Mar. 18, 2026

Related U.S. Application Data
(60) Provisional application No. 63/774,098, filed on Mar. 18, 2025.

(51) Int. Cl. A63F 7/30; A63F 7/02; G01V 8/12

(52) U.S. Cl. CPC A63F 7/307; A63F 7/027; G01V 8/12; A63F 2300/8011

(57) ABSTRACT

The present invention relates generally to the field of amusement devices. More specifically, the invention relates to utilization of sensors to detect movement and presence of a pinball on the playfield. The miniature optical interruption sensor assembly comprises a transmitter PCB having an optical emission module, a receiver PCB having an optical detection module, and a bracket aligning both. A continuous light signal is sent from the emission module to the detection module creating a circuit. When a pinball blocks the light signal, preventing the detection module from receiving the light signal, the present invention registers the event as a pinball detection.

### CROSS-REFERENCES TO RELATED APPLICATIONS

This application claims the benefit of United States Provisional Application Serial Nos. 63/774,098, filed Mar. 18, 2025 entitled Miniature Optical Interruption Sensors which is incorporated by reference herein.

### STATEMENT REGARDING FEDERALLY SPONSORED RESEARCH OR DEVELOPMENT

Not applicable.

### BACKGROUND OF THE INVENTION

### 1. Field of the Invention.

The present invention relates generally to the field of amusement devices. More specifically, the invention relates to utilization of sensors to detect movement and presence of a pinball on the playfield.

### 2. Background of Related Art.

A traditional pinball game utilizes defined ball paths on a playfield surface. Detecting a ball’s passage through these paths is critical for scoring, triggering mechanisms, and tracking gameplay. Historically, this detection is achieved via mechanical rollover switches typically a microswitch with a wire striker protruding through a slot in the playfield or leaf-spring switches that complete a circuit upon physical impact.

While these mechanical systems are common, they suffer from several significant technical limitations. First, mechanical fatigue is a primary failure point; constant high-velocity impacts cause pitting of contact points, deformation of metal, and eventual component breakage, necessitating frequent manual recalibration. Second, these physical interfaces interfere with ball dynamics. The friction from a striker wire can slow the ball, alter its trajectory, or create dead spots where a ball may become trapped. Additionally, open-contact switches are highly susceptible to environmental degradation. Debris, wax, and oxidation lead to failures in the system to register hits, undermining reliability in high-traffic environments.

Accordingly, there exists, therefore, a need for a pinball architecture that replaces high-wear mechanical interfaces with an integrated sensor-based system such as optical sensing arrays capable of high-resolution tracking, reduced mechanical failure, and a reduced spatial footprint to enable miniaturization and enhanced data collection.

### SUMMARY OF THE INVENTION

The present invention utilizes miniature optical interruption sensors to detect movement of a pinball without contacting the pinball. The miniature optical interruption sensor assembly comprises a printed circuit board (PCB) containing an optical emission module (hereinafter “transmitter PCB”) and a printed circuit board (PCB) containing an optical detection module (hereinafter “receiver PCB”) wherein the transmitter PCB and the receiver PCB are aligned. The transmitter PCB constantly transmits a beam of light and the receiver PCB detects the beam of light. When an object is positioned between the emission module and detection module, such as a pinball, the detection module no longer receives the beam of light, registers the interruption, and sends a signal that the beam has been interrupted. This signals the presence of a pinball at this location. In the preferred embodiment, the printed circuit boards comprise all the circuitry required such that when the beam of light is interrupted, the sensor acts as a mechanical switch and completes a circuit.

The optical interrupter sensor assembly does not require a cutout in the ball path meaning there is no contact with the pinball, no structure to cause the pinball to get stuck, can sense the pinball across the entire width of the ball path, and is likely to register a bouncing pinball. The miniature optical interruption sensor assembly can be used to measure the movement of a pinball in areas where space is constrained such as a ramp, subway, or mechanism. Finally, the miniature optical interruption sensor assembly may be used in serial to determine speed of a pinball.

The present invention provides several arrangements of the transmitter PCB and receiver PCB in which they may be mounted on the under surface of the playfield, mounted to the playfield, mounted to a ramp or other pathway on the playfield, or connected to a bracket.

### BRIEF SUMMARY OF THE DRAWINGS

FIG. 1 shows an isometric view of the miniature optical interruption sensor assembly.

FIG. 2 shows the front and back surfaces of the transmitter PCB and the receiver PCB.

FIG. 3 shows the front and back surfaces of the transmitter PCB and the receiver PCB.

FIG. 4 shows the transmitter PCB and the receiver PCB mounted to a screw-on bracket with small locating covers and rivets.

FIG. 5 shows the transmitter PCB and the receiver PCB mounted to a weld-on bracket with full locating covers and screws.

FIG. 6 shows an isometric and profile view of the miniature optical interruption sensor assembly mounted to a wire ramp.

FIG. 7 shows an isometric view of the miniature optical interruption sensor assembly in the through playfield embodiment (playfield not shown).

FIG. 8 shows the miniature optical interruption sensor assembly in the through playfield embodiment mounted to an underside playfield bracket (playfield not shown).

FIG. 9 shows a top view of the miniature optical interruption sensor assembly in the through playfield embodiment mounted through a playfield.

FIG. 10 shows a bottom view of the miniature optical interruption sensor assembly in the through playfield embodiment mounted through a playfield.

### DETAILED DESCRIPTION OF THE INVENTION

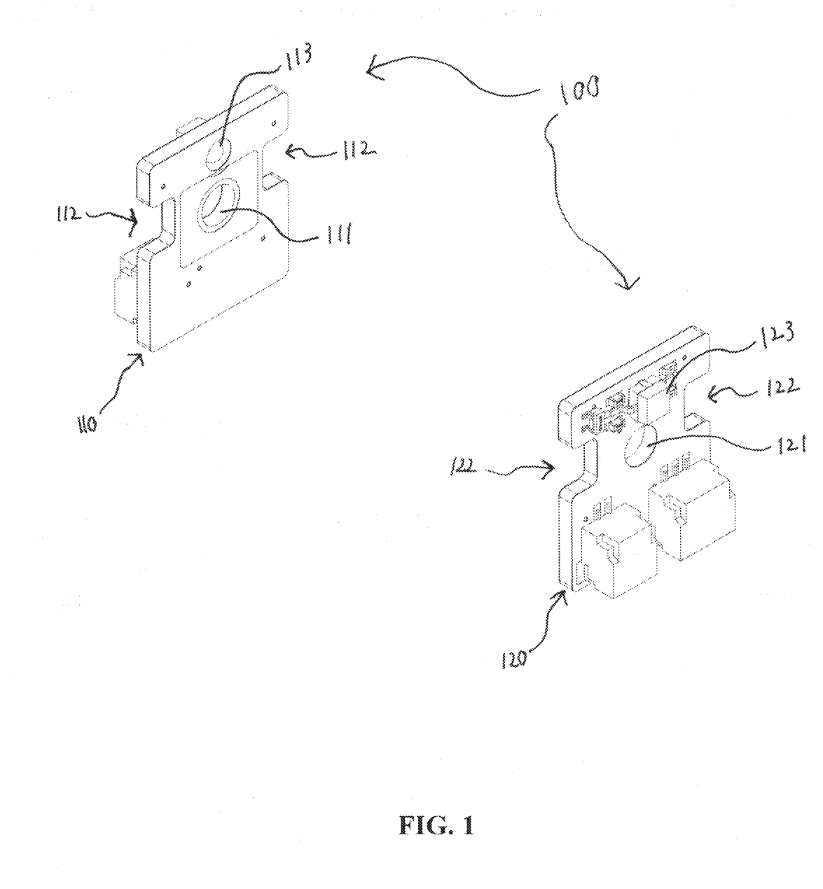

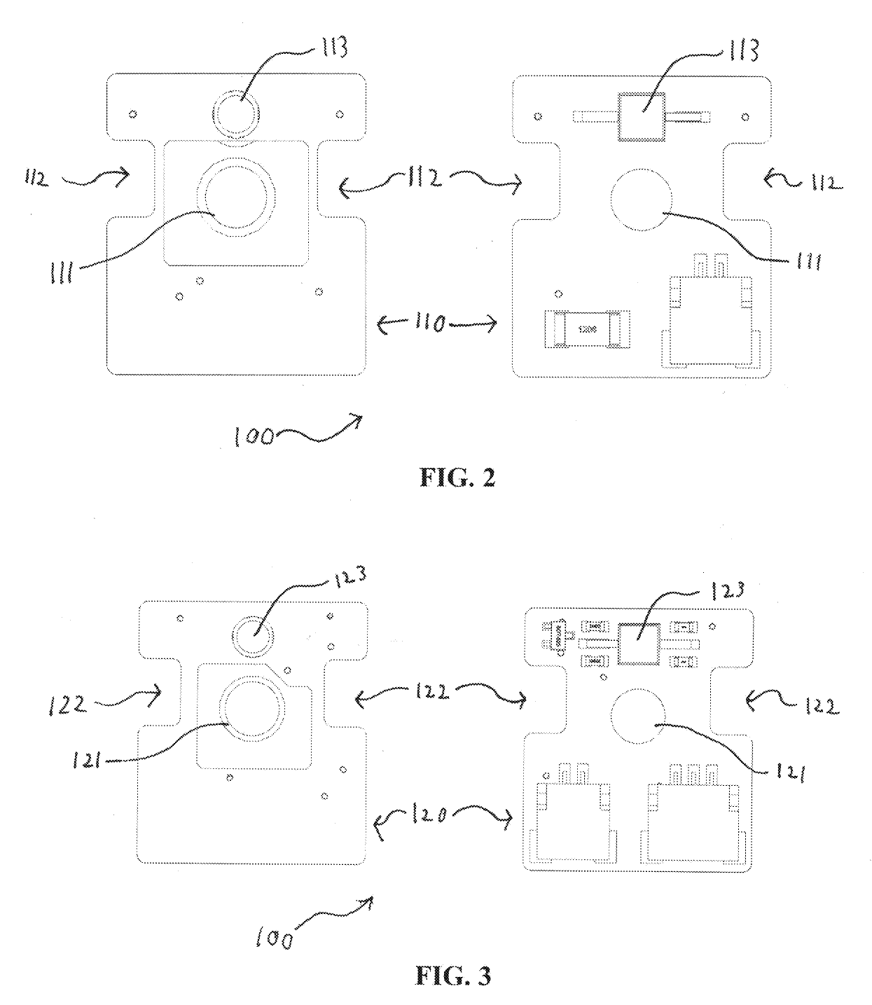

As seen in FIGS. 1-3, the miniature optical interruption sensor assembly 100 comprises a transmitter PCB 110 and a receiver PCB 120. The transmitter PCB 110 comprises a hole 111, a cutout 112, and an optical emission module 113 having a lens, a power input connector, and circuitry and components required for operation. While the preferred embodiment discloses the optical emission module 113, any transmitter that transmits a signal in a linear form such a light beam may be used. The transmitter PCB 110 is in electronic communication with optical emission module 113 and other circuitry components.

The receiver PCB 120 comprises a hole 121, and cutout 122, and an optical detection module 123 having a lens, a power output connector, a switch power and signal connector, and circuitry and components required for operation. While the preferred embodiment discloses an optical detection module 123, any receiver capable of receiving a signal in a linear form such a light beam may be used. In the preferred embodiment the optical detection module 123 is an optical interruption reception sensor. The power input for the transmitter PCB 110 is provided by the power output from the receiver PCB 120 via wiring harness so that only one wire harness is required to connect the miniature optical interruption sensor assembly 100 to the playfield for operation.

The optical emission module 113 and optical detection module 123 are both reverse mounted to the respective transmitter PCB 110 and a receiver PCB 120. This allows for the lenses to be located completely within the thickness of the transmitter PCB 110 and a receiver PCB 120 to further reduce the total footprint of the miniature optical interruption sensor assembly 100. The transmitter PCB 110 and a receiver PCB 120 both have holes 111, 121 near the center for mounting and two inset cutouts 112, 122 in the sides to provide for alignment. The transmitter PCB 110 and a receiver PCB 120 are aligned such that the optical detection module 123 can detect the light emitted from the optical emission module 113. In the preferred embodiment, the respective transmitter PCB 110 and a receiver PCB 120 are as small as possible to contain all components required for operation, connection, and mounting.

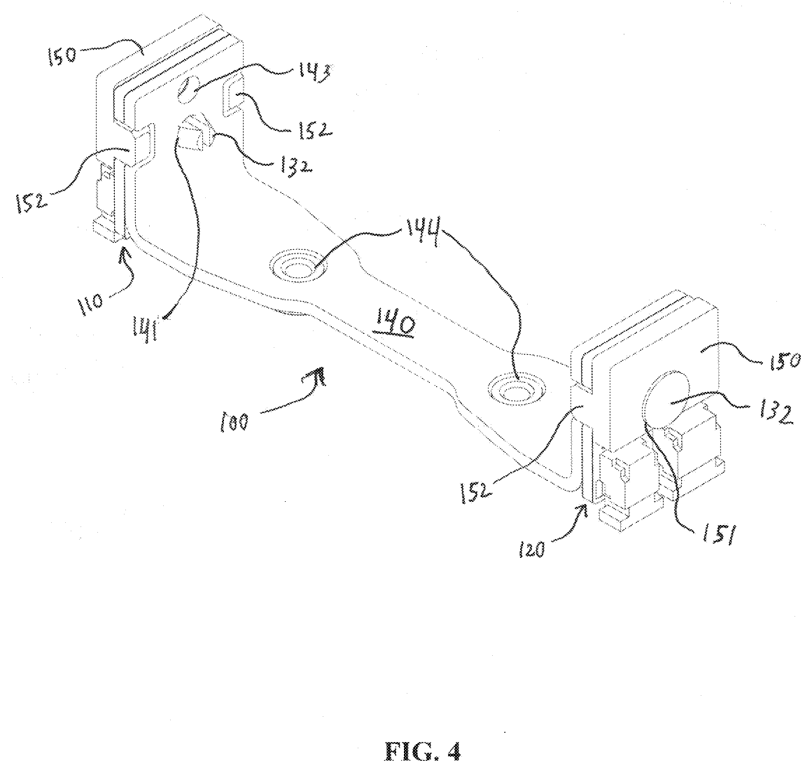

As seen in FIG. 4, the miniature optical interruption sensor assembly 100 further comprises a singular mounting bracket 140, PCB covers 150, and fasteners 131, 132, that fasten the covers and secure the transmitter PCB 110 and a receiver PCB 120 to the bracket 140. The bracket 140 comprises holes 141 that correspond to the holes near the center of the transmitter PCB holes 111 and the receiver PCB holes 121 as well as inset cutouts 142 that match the transmitter PCB cutouts 112 and the receiver PCB cutouts 122 for mounting, and holes 143 that align with the optical emission 113 and detection modules 123 to allow for the beam of light to pass through the bracket 140. The covers 150 protect exposed circuitry and block external sources of light that could interfere with the optical emission 113 and detection modules 123. The covers 150 comprise a hole 151 near the center for mounting, as well as two tabs 152 that engage with the corresponding cutouts in the transmitter PCB 110 and a receiver PCB 120 and bracket 140 to ensure proper alignment. A fastener 132, such as a snap-in plastic rivet, passes through the holes 151 in the cover 150, PCB, and bracket 140 to hold the assembly together for both the transmitter PCB 110 and receiver PCB 120.

The bracket 140 further contains threaded holes 144 to allow it to be mounted to a playfield mechanism such as a ramp with a flat bottom using threaded fasteners. In this embodiment, the covers 150 and fastener 132 do not extend past the thickness of the wire harness connectors on the PCBs providing an ultra low profile implementation.

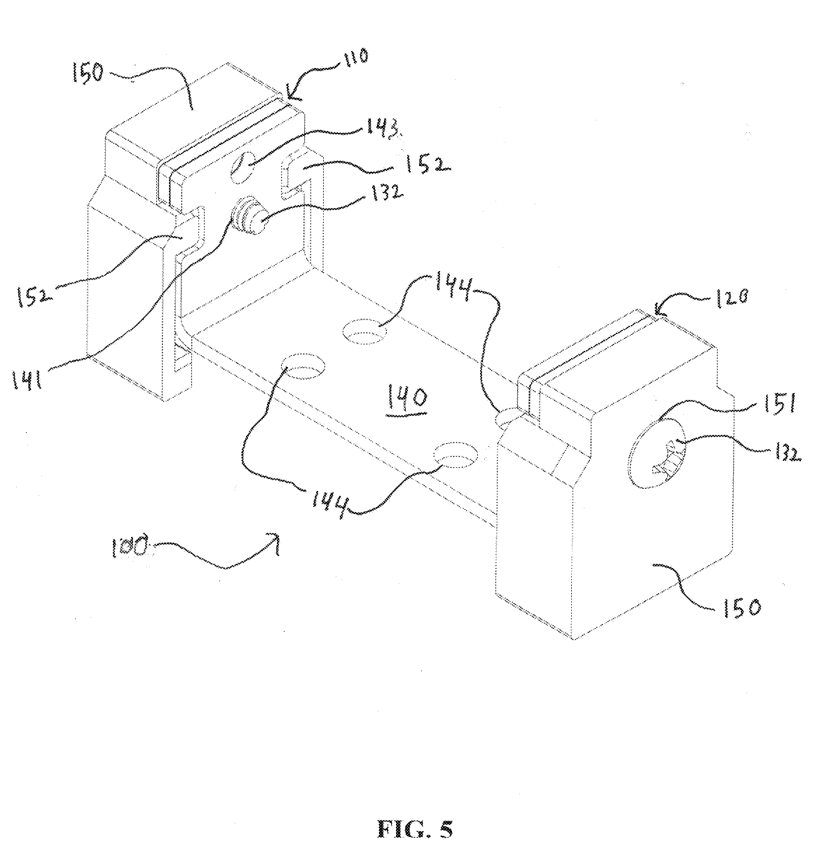

The miniature optical interruption sensor assembly 100 as seen in FIG. 5, is a variation from the disclosure of FIG. 4. Bracket 140 has holes 144 for plug welds to allow it to be welded to a playfield mechanism such as a wire ramp. It further comprises two larger covers 150 that completely cover the back surfaces of the transmitter PCB 110 and a receiver PCB 120 as well as the wire harness connectors to ensure maximum protection. The covers 150 are attached to the bracket 140 using self-threading screws for increased durability over the plastic snap in rivets shown in FIG. 4.

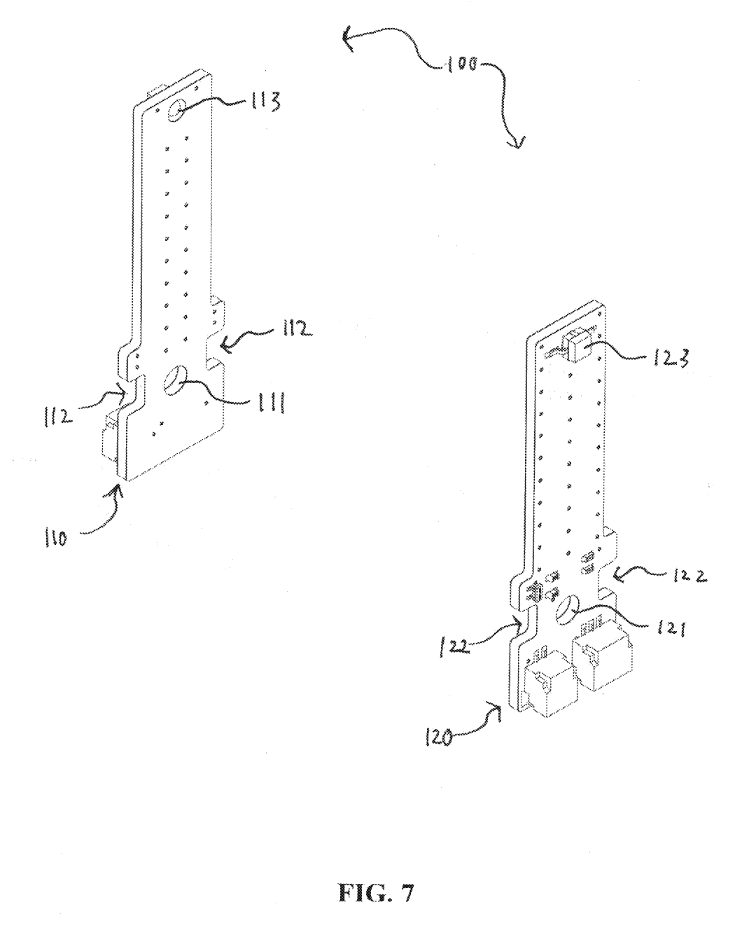

As seen in FIGS. 7-10, the miniature optical interruption sensor assembly 100 can be mounted to the bottom surface of a playfield, positioned thorough the playfield, and used to measure the movement of a pinball on the top surface of a playfield. As seen in FIG. 7, in the through playfield embodiment, the transmitter PCB 110 and receiver PCB 120 are extended at the ends housing the optical emission 113 and detection 123 modules such that the controlling circuitry and wiring harness connectors can be located beneath the bottom surface of a playfield and the light beam can be located above the playfield surface. Only the emission 113 and detection 123 modules are located on the portion of the transmitter PCB 110 and receiver PCB 120 that extend through the playfield so that the size of the cutout in the playfield and the volume taken up by the PCBs above the playfield can be minimized to a very small footprint.

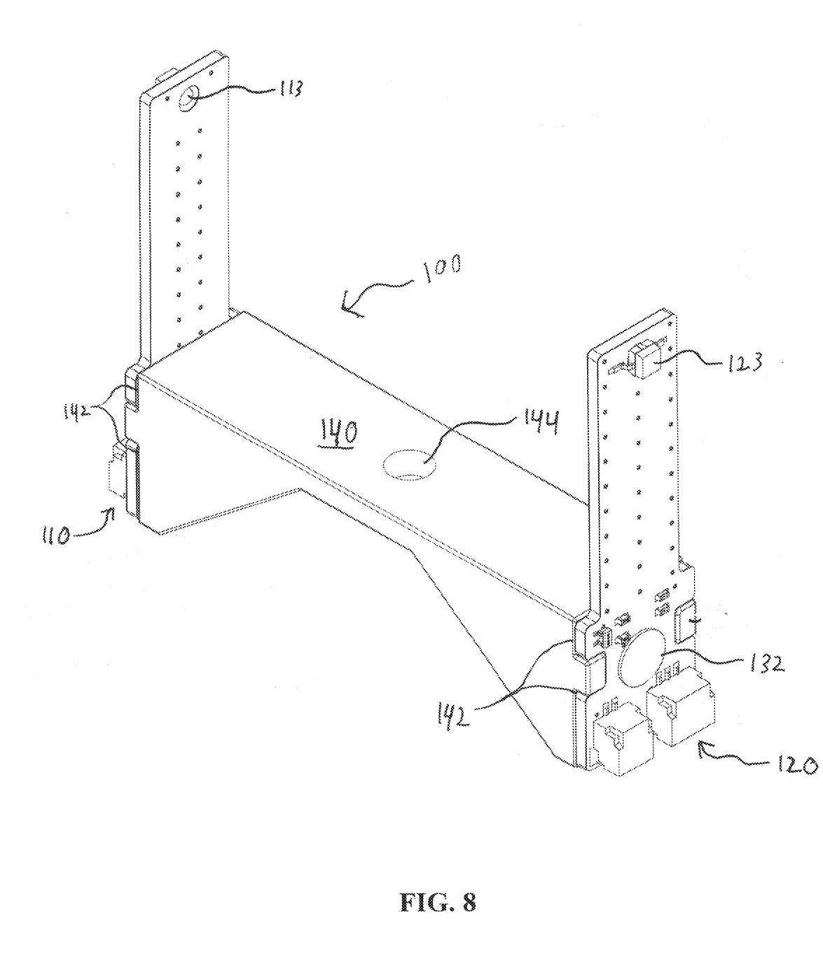

As seen in FIG. 8, the miniature optical interruption sensor assembly 100 comprises an extended transmitter PCB 110, an extended receiver PCB 120, a bracket 140, and two plastic snap-in plastic rivets 132. The bracket 140 comprises two tabs 131 on either end that engage with the corresponding cutouts in the transmitter PCB 110 and receiver PCB 120 to facilitate alignment of the optical emission 113 and detection 123 modules. The bracket 140 further comprises two holes 151 corresponding to the mount holes 111 and 121 near the center of the PCBs so that a fastener can be used to secure the transmitter PCB 110 and receiver PCB 120 to the ends of the bracket 140, and a third hole 144 located vertically through the center of the bracket 140 to allow for the bracket 140 to be attached to the bottom surface of a playfield using a single fastener 132.

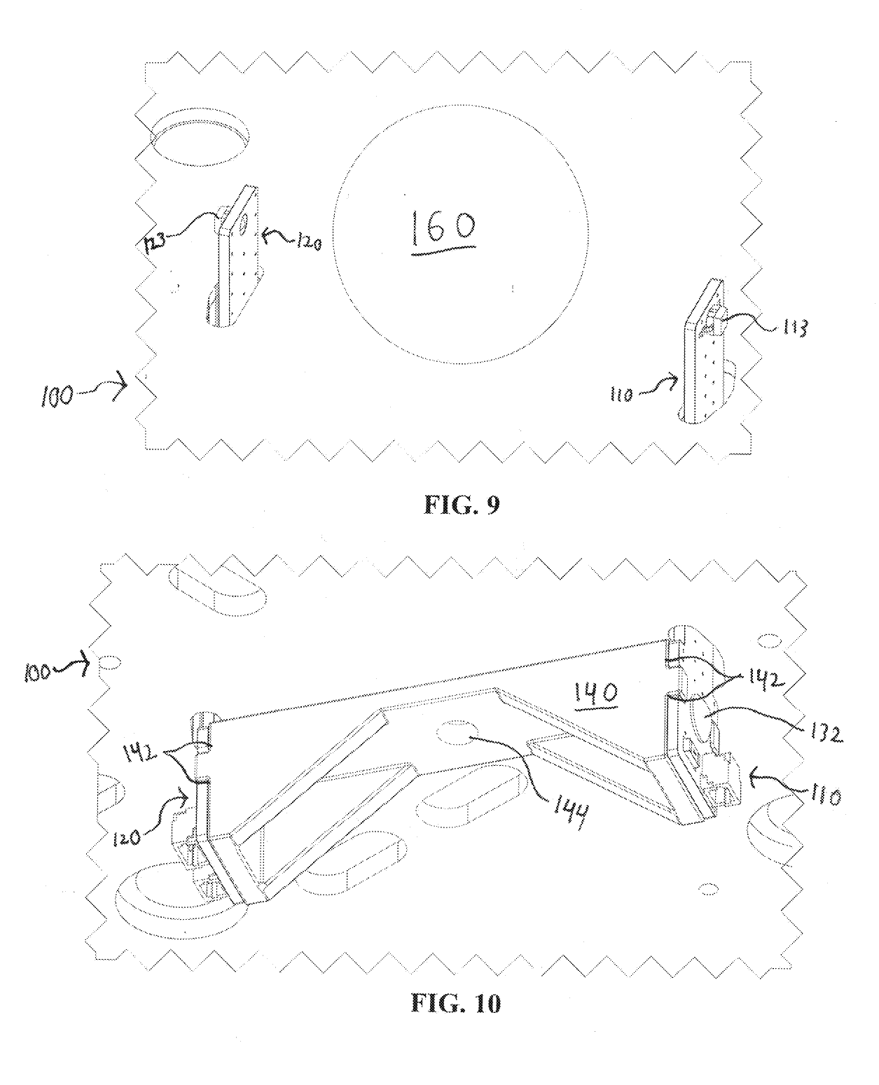

As seen in FIGS. 9-10, the through playfield miniature optical interruption sensor assembly 100 can be mounted to the underside of a playfield comprising a bottom surface, a top surface, and two cutouts corresponding to the location of the transmitter PCB 110 and receiver PCB 120. The cutouts are slightly larger than the profile of the extended end of the transmitter PCB 110 and receiver PCB 120 containing the optical emission 113 and detection 123 modules, minimizing the size of the cutout required for the PCBs due to all controlling circuitry and connectors being located below the playfield. The transmitter PCB 110 and receiver PCB 120 are attached to the mounting bracket 140 prior to being installed. The PCB extended ends are passed through the playfield from the bottom side, and the bracket 140 is attached to the bottom surface of the playfield using a single fastener 132. The portion of the PCBs that protrude through the top surface of the playfield can be located behind ball guides or other playfield interfaces 170 easily due to their small size to prevent them from being contacted and damaged by a pinball 160.

As seen in FIGS. 4-6 and 8-10, bracket 140 is used to create coaxial alignment of the optical emission 113 and detection modules 123. The bracket 140 is capable of being any number of sizes, shapes, and orientations depending on the space needed to detect a pinball. The bracket 140 is placed in the playfield in a way that orients the optical emission 113 and detection modules 123 perpendicular to the path that the pinball 160 traverses or is expected to traverse. When the pinball 160 traverses along one of the various paths available and passes between the optical emission 113 and detection modules 123 the signal emitted by the optical emission 113 is broken so that the optical detection module 123 no longer receives a signal temporarily. This results in an event occurring, which causes miniature optical interruption sensor assembly 100 to send an event signal to a scoring system. The event signal is translated to a numerical value for display to a user.

The bracket 140, may be used with the playfield, ramps, wireforms, ball trough, and other locations in a pinball game known to those skilled in the art. Communication with the various locations within the pinball game may be accomplished through welding, soldering, using fasteners, and other known and yet discovered methods of communication. In some embodiments the bracket 140, is a monolithic body capable of supporting both the transmitter PCB 110 and receiver PCB 120. As an example, the bracket 140, may comprise a plurality of brackets 140, in most instances, a first support member and a second support member.

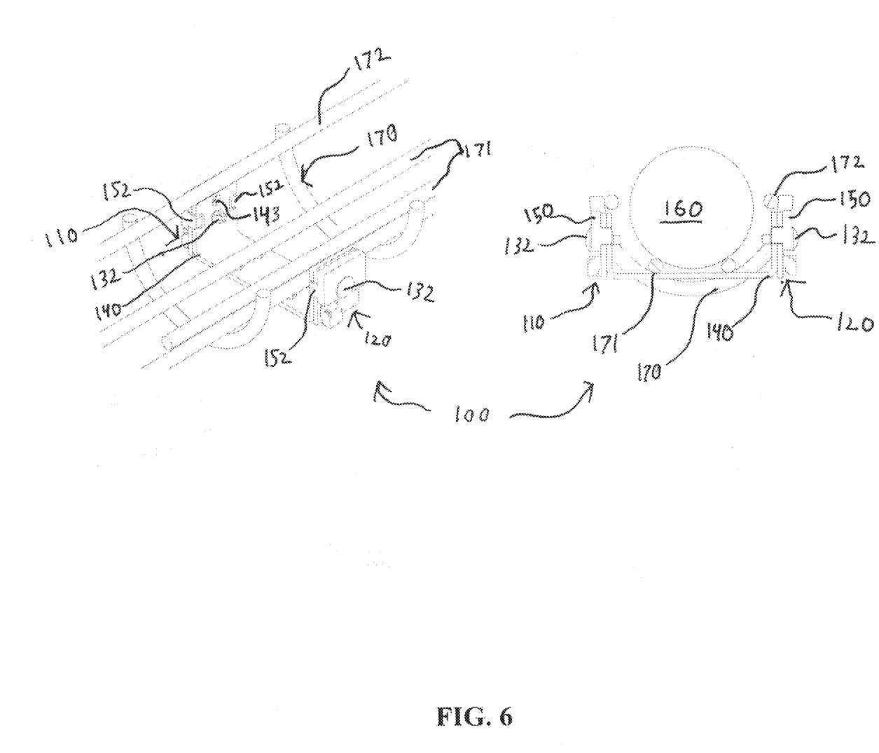

As shown in FIG. 6, the bracket 140 of the miniature optical interruption sensor assembly 100 is welded directly to wire ramp 170. The transmitter PCB 110 and a receiver PCB 120 are positioned such that the light beam passing from the emission module 113 to the detection module 123 passes between the lower wires 171 and upper wires 172 of the wire ramp 170. When a pinball 160 passes through that section of the ramp 170, the signal emitted by the emission module 113 is blocked so that the detection module 123 no longer receives the signal. This interruption, whether temporary or longer, means the pinball 160 is detected at that location.

As shown in FIG. 9, transmitter PCB 110 and receiver PCB 120 are placed directly into the field of play through mounting under the playfield via bracket 140. The optical emission 113 and detection modules 123 are supported and aligned by placing them in direct communication in a variety of spatial arrangements in which transmitter PCB 110 and receiver PCB 120 may fit and the pinball 160 may traverse. Any arrangement in permissible so long as the optical emission 113 and detection modules 123 are aligned. When the pinball 160 traverses along one of the various paths available and passes between the optical emission 113 and detection modules 123, the signal emitted by the emission module 113 is blocked so that the detection module 123 no longer receives the signal. This interruption, whether temporary or longer, means the pinball 160 is detected at that location. This results in an event occurring, which causes the miniature optical interruption sensor assembly 100 to send an event signal to the game system.

The transmitter PCB 110 and receiver PCB 120 may be mounted directly to a playfield component such as ball guides, ramp side panels, subway sides, or any other spatial location so long as the emission module 113 and detection module 123 are aligned. Further, multiple miniature optical interruption sensor assemblies 100 may be placed in quick succession or serially and used to calculate the speed of a pinball.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through the several views.

The description of the present invention has been presented for purposes of illustration and description and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

1. A miniaturized proximity sensor for use on a pinball game/amusement devices comprising:
a transmitter placed in electrical communication with a transmitter printed computer board;
the transmitter disposed onto the transmitter printed computer board;
a receiver placed in electrical communication with a receiver printed computer board;
the receiver disposed onto the receiver printed computer board;
the disposed transmitter mounted to a playfield; and
the disposed receiver mounted to the playfield.

2. The miniaturized proximity sensor of claim 1, wherein the disposed transmitter is coaxially aligned with the disposed receiver.

3. The miniaturized proximity sensor of claim 1, wherein the transmitter emits a signal that the receiver detects.

4. The miniaturized proximity sensor of claim 3, wherein the receiver stops receiving the signal from the transmitter, the receiver printed computer board generates an event signal.

5. The miniaturized proximity sensor of claim 1, wherein the receiver and the transmitter have a protective housing.

6. A miniaturized optical interruption sensor comprising:
an optoelectrical transmitter placed in communication with a transmitter printed computer board;
an optoelectrical receiver placed in communication with a receiver printed computer board;
the disposed optoelectrical transmitter supported by a support member;
the disposed optoelectrical receiver supported by the support member;
a protective transmitter housing disposed upon the disposed optoelectrical transmitter; and
a protective receiver housing disposed upon the disposed optoelectrical receiver.

7. The miniaturized optical interruption sensor of claim 6 wherein the support member places the optoelectrical transmitter and optoelectrical receiver in fixed optical alignment.

8. The miniaturized optical interruption sensor of claim 6 wherein the optoelectrical transmitter is disposed onto the transmitter printed computer board.

9. The miniaturized optical interruption sensor of claim 6 wherein the optoelectrical receiver is disposed onto the receiver printed computer board.

10. The miniaturized optical interruption sensor of claim 6 wherein the support member is a monolithic body.

11. The miniaturized optical interruption sensor of claim 6 wherein the support member comprises at least one body.

12. A miniaturized optical interruption sensor comprising:
an optoelectrical transmitter placed in electrical communication with a transmitter printed computer board;
The optoelectrical transmitter disposed onto the transmitter printed computer board;
an optoelectrical receiver placed in electrical communication with a receiver printed computer board;
the optoelectrical receiver disposed onto the receiver printed computer board;
the disposed optoelectrical transmitter supported by a support member; and
the disposed optoelectrical receiver supported by the support member.

13. The miniaturized optical interruption sensor of claim 12 wherein the support member is a monolithic body.

14. The miniaturized optical interruption sensor of claim 12 wherein the support member comprises a first body and a second body.

15. The miniaturized optical interruption sensor of claim 12 wherein the optoelectrical transmitter is coaxially aligned with the optoelectrical receiver.

16. The miniaturized proximity sensor of claim 12, wherein the optoelectrical transmitter has a protective transmitter housing.

17. The miniaturized proximity sensor of claim 12, wherein the optoelectrical receiver has a protective receiver housing.
